(19) United States
(12) Patent Application Publication
(10) Pub. No.: US 2007/0243502 A1
(43) Pub. Date: Oct. 18, 2007

(54) Digitization of target dental arch model

(76) Inventor: Huafeng Wen, Redwood City, CA (US)

Correspondence Address: PAUL, HASTINGS, JANOFSKY & WALKER LLP, P.O. BOX 919092, SAN DIEGO, CA, 92191-9092, US

(21) Appl. No.: 11/405,972

(22) Filed: Apr. 17, 2006

(51) Int. Cl. A61C 9/00

(52) U.S. Cl. 433/214

(57) ABSTRACT

Methods and apparatus are disclosed for generating digital models of arrangements of a patient's teeth. The methods comprise acquiring a physical model of an arrangement of the patient's teeth, and generating a digital model of the arrangement from the physical model. Arrangements of the patient's teeth that may be digitally modeled by these methods include, but are not limited to, the current arrangement of the patient's teeth in the patient's mouth, a predicted or desired post-treatment arrangement of the patient's teeth, an arrangement of teeth intermediate between the current and predicted or desired post-treatment arrangement, or another arrangement of the patient's teeth that is modified compared to the current arrangement. In some variations, the digital model may be used in the fabrication of dental appliances including but not limited to dental aligners.

### CROSS-REFERENCE TO RELATED APPLICATIONS

The present application is related to International Patent Application No. PCT/US2005/039715 titled “METHODS AND APPARATUSES FOR MANUFACTURING DENTAL ALIGNERS,” filed Nov. 2, 2005, International Patent Application No. PCT/US2005/045351 titled “IMAGE BASED ORTHODONTIC TREATMENT METHODS,” filed Dec. 14, 2005, and U.S. patent application Ser. No. 11/258,465, entitled “MULTI-LAYER CASTING METHODS AND DEVICES,” filed Oct. 24, 2005, all of which are incorporated herein by reference in their entirety.

### TECHNICAL FIELD

This application generally relates to the field of dental care, and more particularly to the field of orthodontics.

### BACKGROUND

Orthodontics is the practice of manipulating a patient's teeth to provide better function and appearance. Typically, brackets are bonded to a patient's teeth and coupled together with an arched wire. The combination of the brackets and wire provide a force on the teeth causing them to move. Once the teeth have moved to a desired location and are held in a place for a certain period of time, the body adapts bone and the surrounding soft-tissue to maintain the teeth in the desired location. To further assist in retaining the teeth in the desired location, a patient may be fitted with a retainer.

To achieve tooth movement, orthodontists utilize their expertise to first determine a three-dimensional mental image of the patient's physical orthodontic structure and a three-dimensional mental image of a desired physical orthodontic structure for the patient, which may be assisted through the use of X-rays and/or models. Based on these mental images, the orthodontist further relies on his/her expertise to place the brackets and/or bands on the teeth and to manually bend (i.e., shape) wire, such that a force is asserted on the teeth to reposition the teeth into the desired physical orthodontic structure. As the teeth move towards the desired location, the orthodontist makes continual judgments as to the progress of the treatment, plans next steps in the treatment (e.g., determines new bends in the wire, repositions or replaces brackets, decides whether a head gear is required, etc.), and evaluates the success of the previous steps.

In general, the orthodontist makes manual adjustments to the wire and/or replaces or repositions brackets based on his or her expert opinion. Unfortunately, in the oral environment, it is difficult for a human being to accurately develop a visual three-dimensional image of an orthodontic structure due to the limitations of human sight and the physical structure of a human mouth. In addition, it is difficult to accurately estimate three-dimensional wire bends (with accuracy within a few degrees) and to manually apply such bends to a wire. Further, it is hard to determine an ideal bracket location to achieve the desired orthodontic structure based on the mental images. It is also extremely difficult to manually place brackets in what is estimated to be the ideal location. Accordingly, orthodontic treatment is an iterative process requiring multiple wire changes, with the process success and speed being very much dependent on the orthodontist's motor skills and diagnostic expertise. As a result of multiple wire changes, patient discomfort and cost are increased. As one would expect, the quality of care varies greatly from orthodontist to orthodontist as does the amount of time required to treat a patient.

Over the years, various methods and devices have been developed to assist dentists with delivery of orthodontic treatments. Examples of these methods and devices are disclosed in U.S. Pat. No. 6,699,037 B2 titled “METHOD AND SYSTEM FOR INCREMENTALLY MOVING TEETH” issued to Chishti et al., dated Mar. 2, 2004; U.S. Pat. No. 6,682,346 B2 titled “DEFINING TOOTH-MOVING APPLIANCES COMPUTATIONALLY” issued to Chishti et al., dated Jan. 27, 2004; U.S. Pat. No. 6,471,511 titled “DEFINING TOOTH-MOVING APPLIANCES COMPUTATIONALLY” issued to Chishti et al., dated Oct. 29, 2002; U.S. Pat. No. 5,645,421 titled “ORTHODONTIC APPLIANCE DEBONDER” issued to Slootsky, dated Jul. 8, 1997; U.S. Pat. No. 5,618,176 titled “ORTHODONTIC BRACKET AND LIGATURE AND METHOD OF LIGATING ARCHWIRE TO BRACKET” issued to Andreiko et al., dated Apr. 8, 1997; U.S. Pat. No. 5,607,305 titled “PROCESS AND DEVICE FOR PRODUCTION OF THREE-DIMENSIONAL DENTAL BODIES” issued to Andersson et al., dated Mar. 4, 1997; U.S. Pat. No. 5,605,459 titled “METHOD OF AND APPARATUS FOR MAKING A DENTAL SET-UP MODEL” issued to Kuroda et al., dated Feb. 25, 1997; U.S. Pat. No. 5,587,912 titled “COMPUTER AIDED PROCESSING OF THREE-DIMENSIONAL OBJECT AND APPARATUS THEREFOR” issued to Andersson et al., dated Dec. 24, 1996; U.S. Pat. No. 5,549,476 titled “METHOD FOR MAKING DENTAL RESTORATIONS AND THE DENTAL RESTORATION MADE THEREBY” issued to Stem, dated Aug. 27, 1996; U.S. Pat. No. 5,533,895 titled “ORTHODONTIC APPLIANCE AND GROUP STANDARDIZED BRACKETS THEREFOR AND METHODS OF MAKING, ASSEMBLING AND USING APPLIANCE TO STRAIGHTEN TEETH” issued to Andreiko et al., dated Jul. 9, 1996; U.S. Pat. No. 5,518,397 titled “METHOD OF FORMING AN ORTHODONTIC BRACE” issued to Andreiko et al., dated May 21, 1996; U.S. Pat. No. 5,474,448 titled “LOW PROFILE ORTHODONTIC APPLIANCE” issued to Andreiko et al., dated Dec. 12, 1995; U.S. Pat. No. 5,454,717 titled “CUSTOM ORTHODONTIC BRACKETS AND BRACKET FORMING METHOD AND APPARATUS” issued to Andreiko et al., dated Oct. 3, 1995; U.S. Pat. No. 5,452,219 titled “METHOD OF MAKING A TOOTH MOLD” issued to Dehoff et al., dated Sep. 19, 1995; U.S. Pat. No. 5,447,432 titled “CUSTOM ORTHODONTIC ARCHWIRE FORMING METHOD AND APPARATUS” issued to Andreiko et al., dated Sep. 5, 1995; U.S. Pat. No. 5,431,562 titled “METHOD AND APPARATUS FOR DESIGNING AND FORMING A CUSTOM ORTHODONTIC APPLIANCE AND FOR STRAIGHTENING OF TEETH THEREWITH” issued to Andreiko et al., dated Jul. 11, 1995; U.S. Pat. No. 5,395,238 titled “METHOD OF FORMING ORTHODONTIC BRACE” issued to Andreiko et al., dated Mar. 7, 1995; U.S. Pat. No. 5,382,164 titled “METHOD FOR MAKING DENTAL RESTORATIONS AND THE DENTAL RESTORATIONS MADE THEREBY” issued to Stem, dated Jan. 17, 1995; U.S. Pat. No. 5,368,478 titled “METHOD FOR FORMING JIGS FOR CUSTOM PLACEMENT OF ORTHODONTIC APPLIANCES ON TEETH” issued to Andreiko et al, dated Nov. 29, 1994; U.S. Pat. No. 5,342,202 titled “METHOD FOR MODELING CRANIO-FACIAL ARCHITECTURE” issued to Deshayes, dated Aug. 30, 1994; U.S. Pat. No. 5,340,309 titled “APPARATUS AND METHOD FOR RECORDING JAW MOTION” issued to Robertson, dated Aug. 23, 1994; U.S. Pat. No. 5,338,198 titled “DENTAL MODELING SIMULATOR” issued to Wu et al., dated Aug. 16, 1994; U.S. Pat. No. 5,273,429 titled “METHOD AND APPARATUS FOR MODELING A DENTAL PROSTHESIS” issued to Rekow et al., dated Dec. 28, 1993; U.S. Pat. No. 5,186,623 titled “ORTHODONTIC FINISHING POSITIONER AND METHOD OF CONSTRUCTION” issued to Breads et al., dated Feb. 16, 1993; U.S. Pat. No. 5,139,419 titled “METHOD OF FORMING AN ORTHODONTIC BRACE” issued to Andreiko et al., dated Aug. 18, 1992; U.S. Pat. No. 5,059,118 titled “ORTHODONTIC FINISHING POSITIONER AND METHOD OF CONSTRUCTION” issued to Breads et al., dated Oct. 22, 1991; U.S. Pat. No. 5,055,039 titled “ORTHODONTIC POSITIONER AND METHODS OF MAKING AND USING SAME” issued to Abbatte et al., dated Oct. 8, 1991; U.S. Pat. No. 5,035,613 titled “ORTHODONTIC FINISHING POSITIONER AND METHOD OF CONSTRUCTION” issued to Breads et al., dated Jul. 30, 1991; U.S. Pat. No. 5,011,405 titled “METHOD FOR DETERMINING ORTHODONTIC BRACKET PLACEMENT” issued to Lemchen, dated Apr. 30, 1991; U.S. Pat. No. 4,936,862 titled “METHOD OF DESIGNING AND MANUFACTURING A HUMAN JOINT PROSTHESIS” issued to Walker et al., date Jun. 26, 1990; U.S. Pat. No. 4,856,991 titled “ORTHODONTIC FINISHING POSITIONER AND METHOD OF CONSTRUCTION” issued to Breades et al., dated Aug. 15, 1989; U.S. Pat. No. 4,798,534 titled “METHOD OF MAKING A DENTAL APPLIANCE” issued to Breads, dated Jan. 17, 1989; U.S. Pat. No. 4,755,139 titled “ORTHODONTIC ANCHOR APPLIANCE AND METHOD FOR TEETH POSITIONING AND METHOD OF CONSTRUCTING THE APPLIANCE” issued to Abbatte et al., dated Jul. 5, 1988; U.S. Pat. No. 3,860,803 titled “AUTOMATIC METHOD AND APPARATUS FOR FABRICATING PROGRESSIVE DIES” issued to Levine, dated Jan. 14, 1975; U.S. Pat. No. 3,660,900 titled “METHOD AND APPARATUS FOR IMPROVED ORTHODONTIC BRACKET AND ARCH WIRE TECHNIQUE” issued to Andrews, dated May 9, 1972; each of which is incorporated herein by reference in its entirety for all purposes.

The practice of orthodontics and other dental treatments can benefit from a computer model that is representative of the positions of the teeth in a tooth arch. The computer model may be prepared based on an impression model,taken from the patient. The computer model may be utilized to assist the dentist in planning an orthodontic treatment regimen by providing visual feedback of possible treatment steps in a particular treatment regimen.

In particular, the computer modeling tool may be useful in designing and manufacturing removable aligning appliances for orthodontic treatment. In some existing systems, a digital model of the initial arrangement of a patient's teeth is generated from information captured from an impression model of the patient's dentition. A computer is then used to manipulate the digital model of the initial arrangement to produce a digital model of a desired final tooth arrangement. A series of intermediate digital models corresponding to successive tooth arrangements from the initial to final arrangements is generated from the digital models of the initial and final arrangements.

Removable aligning appliances (e.g., devices, shells, etc.) produced based on the intermediate digital models are then used to move the teeth toward the desired final positions. Repositioning is accomplished with a series of such appliances configured to receive the teeth in a cavity and incrementally reposition individual teeth in a series of successive steps. The successive use of a number of such appliances permits each appliance to be configured to move individual teeth in small increments.

The individual appliances typically include a polymeric shell having the tooth-receiving cavity formed therein. Each individual appliance is configured so that its tooth-receiving cavity has a geometry corresponding to an intermediate or end tooth arrangement intended for that appliance. That is, when an appliance is first worn by the patient, certain of the teeth will be misaligned relative to an undeformed geometry of the appliance cavity. The appliance, however, is sufficiently resilient to accommodate or conform to the misaligned teeth, and will apply sufficient resilient force against such misaligned teeth in order to reposition the teeth to the intermediate or end arrangement desired for that treatment step.

Existing systems for fabricating dental aligners from digital models of tooth arrangements may be slow and expensive.

### SUMMARY

Methods and apparatus that may be used to manufacture dental appliances including, but not limited to, removable dental aligners are disclosed. The term “dental aligner” may refer to any dental device for rendering corrective teeth movement or for correcting malocclusion. One or more dental aligners can be worn on the subject's teeth so that a subject wearing the dental aligners will gradually have his or her teeth repositioned by the dental aligner “pushing” (or pulling) against the teeth and/or gums (gingiva). Additional uses for the disclosed methods and apparatuses other than manufacturing dental aligners are also contemplated.

Methods and apparatus for generating digital models of arrangements of a patient's teeth are also disclosed. These may be digital models of, for example, the current arrangement of teeth in the patient's mouth, a predicted or desired post-treatment arrangement of teeth in the patient's mouth expected or intended to result from a treatment plan, or arrangements of a patient's teeth intermediate between the current and predicted or desired post-treatment arrangements. Intermediate and predicted or desired post-treatment arrangements of a patient's teeth may be referred to herein as “target” tooth arrangements or tooth arches. The current arrangement of the patient's teeth may be, for example, a pre-treatment arrangement. Alternatively, the current arrangement may have resulted from a previous treatment or from previous stages of a treatment that the patient is undergoing. A digital model may be generated of an arrangement of teeth that is modified compared to the current arrangement of the patient's teeth. The modified arrangement may be, for example, an intermediate or predicted post-treatment arrangement of the patient's teeth.

In one aspect, a method is disclosed for fabricating one or more dental aligners for repositioning a patient's teeth from a current arrangement to a target arrangement through at least one arrangement intermediate between the current arrangement and the target arrangement. The method may comprise acquiring a digital model of the current arrangement of the patient's teeth, arranging a plurality of physical tooth models of the patient's teeth to form a physical model of the target arrangement, generating a digital model of the target arrangement from the physical model of the target arrangement, generating one or more digital models of intermediate arrangements from the digital model of the current arrangement and the digital model of the target arrangement, and fabricating one or more dental aligners from the one or more digital models of intermediate arrangements.

In some variations, acquiring the digital model of the current arrangement comprises digitizing the patient's tooth arch in the patient's mouth, digitizing a negative impression of the tooth arch, and/or digitizing a positive model of the patient's current tooth arch. Such digitizing may be accomplished, for example, by acquiring images of or scanning the tooth arch, negative impression, and/or positive model. As used herein, scanning may include, but is not limited to, laser scanning, optical scanning, destructive scanning, computed tomography scanning, magnetic resonance imaging scanning, acoustic scanning, and scanning with a mechanical digitizing or scanning device.

The digital model of the current arrangement may also be acquired, for example, by acquiring a negative impression of the patient's tooth arch, casting a positive model of the tooth arch from the negative impression, separating the positive model into a plurality of physical tooth models, generating a plurality of digital tooth models from the plurality of physical tooth models, and generating the digital model of the current arrangement from the digital tooth models. The digital tooth models may be generated, for example, by acquiring images of or scanning the physical tooth models. The relative positions of the teeth in the current arrangement may be determined, for example, by acquiring images of or scanning the patient's tooth arch, a negative impression of the tooth arch, and/or a positive model cast from the negative impression.

In some variations, physical tooth models to be arranged to form a physical model of the target arch are fabricated by separating a positive model of the patient's tooth arch cast from a negative impression, as just described. In other variations, the physical tooth models may be manufactured, for example, by computer numerical control manufacturing based on the digital model of the current arrangement of the patient's teeth. In yet other variations, a physical model of the current arrangement may be manufactured, for example, by computer numerical control manufacturing based on the digital model of the current arrangement and then separated into the physical tooth models.

The physical tooth models may be arranged to form a model of the target arrangement on a wax base, for example. In some variations, arranging the physical tooth models to form a physical model of the target arrangement may comprise arranging the physical tooth models to form a physical model of the current arrangement, and then rearranging the physical tooth models to form the physical model of the target arrangement. As explained in the detailed description, this may make it easier to later determine the correspondence between the teeth in the digital model of the current arrangement and the teeth in the digital model of the target arrangement generated from the physical model of the target arrangement. It is not necessary to first arrange the tooth models to form a model of the current arrangement, however.

In some variations, the physical tooth models are arranged on a wax base that includes at least one receptacle for each of the physical tooth models such that when the physical tooth models are coupled to the receptacles the physical tooth models form a physical model of the current arrangement. The physical tooth models may then be rearranged to form the physical model of the target arrangement by, for example, heating the wax base to soften at least a part of it and thereby allow the location and/or orientation of one or more of the physical tooth models to be altered. The wax may be subsequently hardened to maintain the new positions of the physical tooth models in the wax base. The physical tooth models may be rearranged in this manner to form the physical model of the target arrangement in a single step. Alternatively, the process of softening the wax, altering locations and/or orientations of one or more physical tooth models, and hardening the wax may be repeated one or more times to ultimately form the physical model of the target arrangement.

In other variations, the physical tooth models are attached to a base plate with jigs that allow the locations and orientations of the physical tooth models to be adjusted. This may also allow the physical tooth models to be initially arranged to form a physical model of the current arrangement, and then rearranged to form a physical model of the target arrangement.

Generating the digital model of the target arrangement may comprise, for example, acquiring one or more images of and/or scanning the physical model of the target arrangement. The digital model of the target arrangement may be constructed solely from information acquired from such images and/or scans, or include additional information.

In some variations, the digital model of the target arrangement may be generated from digital tooth models of the patient's teeth and the relative positions of the physical tooth models in the physical model of the target arrangement. The relative positions of the physical tooth models in the physical model of the target arrangement may be determined, for example, by acquiring images of or scanning the physical model of the target arrangement. The relative positions of the teeth in the target arrangement may also be determined, for example, by matching the digital tooth models to teeth in a preliminary digital model of the target arrangement generated from the physical model of the target arrangement. The preliminary digital model may be generated, for example, by acquiring images of or scanning the physical model of the target arrangement.

Generating a digital model of an intermediate arrangement of the patient's teeth may comprise interpolating between the digital model of the current arrangement and the digital model of the target arrangement. The interpolation may be linear or non-linear.

Fabricating a dental aligner may comprise, for example, arranging a plurality of physical tooth models to form a physical model of one of the intermediate arrangements, and then forming (e.g., pressure or vacuum forming) the dental aligner over the physical model. The physical tooth models used in the aligner fabrication process may be the same as those used to form the physical model of the target arch, for example, and may be fabricated by the methods described above. In other variations, fabricating a dental aligner may comprise manufacturing a physical model of one of the intermediate arrangements by computer numerical control manufacturing based on a digital model of the intermediate arrangement, and then forming the dental aligner over the physical model. In yet other variations, fabricating a dental aligner may comprise generating a digital model of the dental aligner from one of the digital models of intermediate arrangements, and manufacturing the dental aligner by computer numerical control manufacturing based on the digital model of the dental aligner.

In another aspect, a method is disclosed for generating one or more digital models of one or more arrangements of a patient's teeth. The method may comprise acquiring a physical model of an arrangement of the patient's teeth that is modified compared to the current arrangement of the patient's teeth, and then generating a digital model of the modified arrangement from the physical model.

In some variations, the physical model of the modified arrangement may comprise a plurality of physical tooth models of the patient's teeth. The physical tooth models may be fabricated, for example, by the methods described above. The digital model of the modified arrangement may be generated, for example, from a plurality of digital tooth models by methods similar or identical to those described above.

The method may further comprise acquiring a digital model of the current arrangement, and generating from the digital models of the current and modified arrangements one or more digital models of arrangements of the patient's teeth intermediate in a dental treatment between the current and modified arrangements. One or more dental appliances such as, for example, dental aligners may be fabricated from the one or more digital models of intermediate arrangements. The digital models of the current and intermediate arrangements may be generated, for example, by methods such as those described above. The dental appliances may be fabricated, for example, by methods similar or identical to those described above with respect to fabricating dental aligners.

In another aspect, another method is disclosed for generating one or more digital models of one or more arrangements of a patient's teeth. The method may comprise attaching a plurality of physical tooth models of the patient's teeth to a platform configured to receive them in an arrangement modeling a current arrangement of the patient's teeth, altering the arrangement of the physical tooth models to model a modified arrangement of the patient's teeth, and generating a digital model of the modified arrangement of the patient's teeth from the altered arrangement of physical tooth models. The physical tooth models may be fabricated, for example, by the methods described above. The digital model of the modified arrangement of the patient's teeth may be generated, for example, by methods similar or identical to those described above.

In some variations, the platform to which the physical tooth models are attached comprises a wax plate that includes a receptacle for each of the physical tooth models such that when the physical tooth models are coupled to the receptacles the physical tooth models model the current arrangement of the patient's teeth. The physical tooth models may then be rearranged to model the modified arrangement of the patient's teeth by, for example, heating the wax to soften it, altering a location and/or orientation of at least one physical tooth model, and then hardening the wax. The physical tooth models may be rearranged in this manner to model the modified arrangement of teeth in a single step. Alternatively, the process of softening the wax, altering locations and/or orientations of one or more physical tooth models, and hardening the wax may be repeated one or more times until the desired arrangement of physical tooth models is achieved.

In other variations, the platform comprises jigs to which the physical tooth models are attached and which allow the locations and orientations of the physical tooth models to be adjusted. One or more of the jigs may be adjusted to alter the location and/or orientation of one or more of the tooth models and thereby rearrange the physical tooth models to model the modified arrangement of the patient's teeth.

The method may further comprise acquiring a digital model of the current arrangement of the patient's teeth, and generating one or more digital models of one or more intermediate arrangements of the patient's teeth from the digital models of the modified and current arrangements. The one or more intermediate arrangements are intermediate in a dental treatment between the current and modified arrangements. One or more dental appliances such as, for example dental aligners may be fabricated from the one or more digital models of intermediate arrangements. The digital models of the current and intermediate arrangements may be generated, for example, by methods such as those described above. The dental appliances may be fabricated, for example, by methods similar or identical to those described above with respect to fabricating dental aligners.

Generating a digital model of an arrangement of a patient's teeth from a physical model of the arrangement may, in some variations, be faster and less expensive than generating the digital model by altering the locations and/or orientations of digital teeth in a digital model of a different (e.g., prior) arrangement. This may result from the relative ease with which physical models of teeth may be manipulated by hand, for example, compared to manipulation by computer mouse of the locations and orientations of digital teeth in a digital model.

Also, in some variations an operator constructing a physical model (to be subsequently digitized) of a modified or target arrangement of the patient's teeth from physical tooth models may sense forces on the physical tooth models and thereby easily detect contact and/or interference between the physical tooth models as they are moved. It may be more difficult to detect such contact or interference when manipulating digital models.

These and other embodiments, features and advantages of the present invention will become more apparent to those skilled in the art when taken with reference to the following more detailed description of the invention in conjunction with the accompanying drawings that are first briefly described.

### BRIEF DESCRIPTION OF THE DRAWINGS

FIG. 1 shows a flow chart for an exemplary process for fabricating dental aligners as described herein.

FIG. 2 shows a perspective view of a casting chamber that may be used to cast a dental arch in some variations.

FIG. 3 shows a base plate for a dental arch attached to a casting chamber lid according to some variations.

FIG. 4 shows the use of a position measurement device to measure the locations and/or orientations of features in a negative impression of a dental arch according to some variations.

FIG. 5 shows a base plate attached to the lid of a casting chamber and placed over the casting chamber so that pins attached to the base plate are positioned within a negative impression of a tooth arch according to some variations.

FIG. 6 shows a positive mold of a patient's tooth arch according to some variations.

FIG. 7 shows physical tooth models separated from the positive mold of FIG. 6 according to some variations.

FIG. 8A shows a scanning system used to digitize physical tooth models according to some variations.

FIG. 8B shows a top view of physical tooth models mounted to a scan plate in the scanning system of FIG. 8A according to some variations.

FIG. 8C shows a side view of physical tooth models mounted to a scan plate in the scanning system of FIG. 8A according to some variations.

FIG. 9 shows examples of graphic projections of digital representations of physical tooth models according to some variations.

FIG. 10 shows a digital representation of a tooth arch generated from the digital representations of individual physical tooth models shown in FIG. 9 according to some variations.

FIG. 11 shows a base plate including sockets to which physical tooth models may be attached to form a dental arch according to some variations.

FIG. 12 shows a wax base plate to which physical tooth models have been attached to form a physical model of the patient's current tooth arrangement according to some variations. The base plate is positioned on a heater that may be used to soften the wax base plate to allow manipulation of the physical tooth models.

FIG. 13 shows the physical tooth models, wax base plate, and heater of FIG. 12 after the physical tooth models have been rearranged according to some variations to form a physical model of a target arrangement of the patient's teeth.

FIG. 14 shows an adjustment jig comprising a universal joint mounted on a translation stage according to some variations.

FIG. 15 shows a polymeric sheet being placed over a physical model of a tooth arch for formation of a removable aligner according to some variations.

FIG. 16 shows a removable aligner formed from the set-up of FIG. 14 according to some variations.

FIG. 17 shows a removable aligner after excess material has been trimmed away according to some variations.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

Before describing the present invention, it is to be understood that unless otherwise indicated this invention need not be limited to applications in orthodontic treatments. As one of ordinary skill in the art having the benefit of this disclosure would appreciate, variations of the invention may be utilized in various other dental applications, such as fabrication and/or treatment planning for dental crowns and dental bridges. The computer models of the tooth arch may also be modified to support research and/or teaching applications. Moreover, it should be understood that variations of the present invention may be applied in combination with various dental diagnostic and treatment devices to improve the condition of a patient's teeth.

It must also be noted that, as used in this specification and the appended claims, the singular forms “a,” “an” and “the” include plural referents unless the context clearly indicates otherwise. Thus, for example, the term “a tooth” is intended to mean a single tooth or a combination of teeth. Furthermore, as used herein, “generating”, “creating”, and “formulating” a digital representation mean the process of utilizing computer calculation to create a numeric representation of one or more objects. For example, the digital representation may comprise a file saved on a computer, wherein the file includes numbers that represent a three-dimensional projection of a tooth arch. In another variation, the digital representation comprises a data set including parameters that can be utilized by a computer program to recreate a digital model of the desired objects.

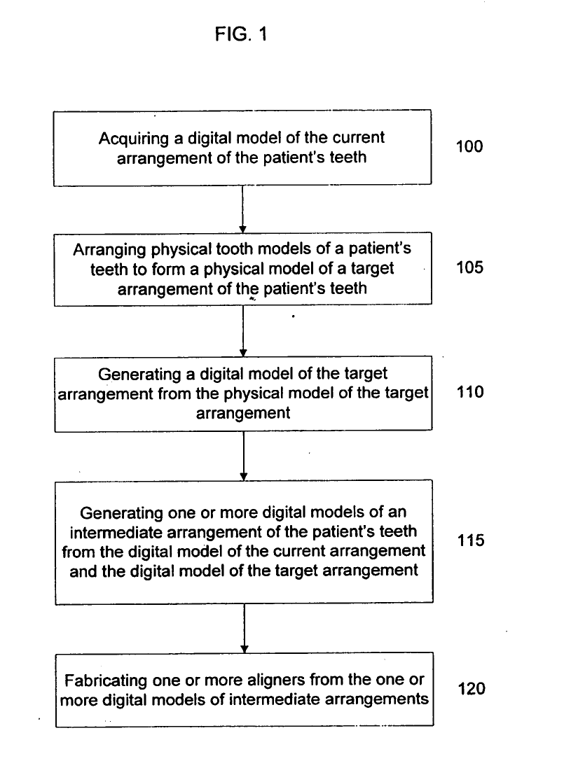

Examples and variations of methods and apparatus that may be used to manufacture dental appliances including, but not limited to, dental aligners are disclosed herein. To illustrate these methods and apparatus, several variations of an exemplary process for manufacturing dental aligners, shown in the flow chart of FIG. 1, are described in detail. Variations of this process need not include all of the steps or apparatus shown in FIG. 1, and may include additional steps and apparatus not shown. The steps need not be executed in the order depicted. One of ordinary skill in the art having the benefit of this disclosure will appreciate that variations of this process and of the disclosed methods and apparatus may be utilized in other dental applications as well.

Examples and variations of methods and apparatus that may be used to generate digital models of arrangements of a patient's teeth are also disclosed herein. These methods and apparatus may be utilized in the manufacture of dental appliances and/or the design of dental treatments, for example, and are described in detail with respect to the exemplary process for manufacturing dental aligners shown in FIG. 1. One of ordinary skill in the art having the benefit of this disclosure will appreciate that variations of these methods and apparatus for generating digital models of arrangements of a patient's teeth may also be utilized in other dental applications.

Referring now to FIG. 1, in step 100 of the exemplary process for manufacturing a dental aligner a digital model of the current arrangement of the patient's teeth in the patient's upper and/or lower tooth arch is acquired. This may be accomplished, for example, by casting a positive mold of the patient's (e.g., upper or lower) tooth arch from a negative impression of the tooth arch, separating the positive mold into individual physical tooth models or physical models of groups of teeth, scanning or otherwise digitizing the physical tooth models, and then generating the digital model of the current arrangement of the patient's teeth from the digital tooth models. Variations of this approach are disclosed in International Patent Application No. PCT/US2005/039715 titled “METHODS AND APPARATUSES FOR MANUFACTURING DENTAL ALIGNERS,” filed Nov. 2, 2005.

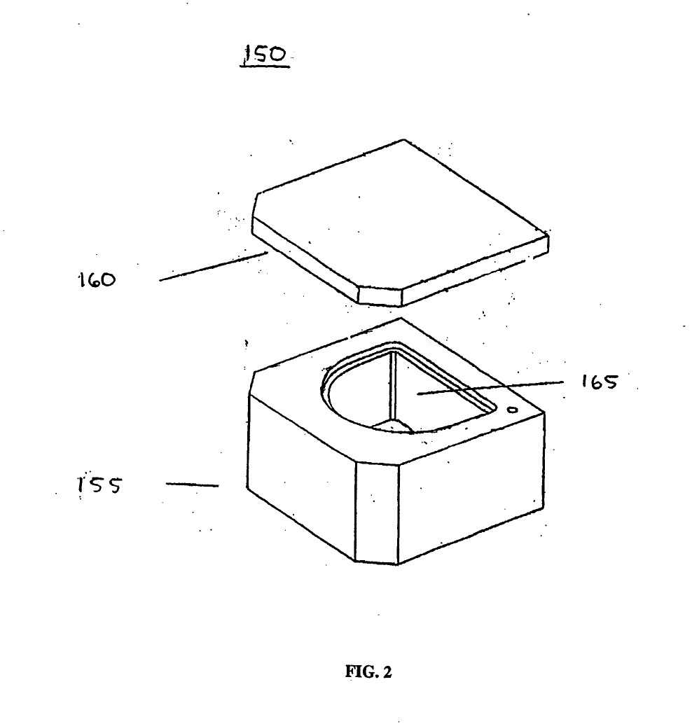

Some variations of the approach just described for acquiring a digital model of the current arrangement of the patient's teeth are described next with respect to FIGS. 2-10. First, a negative impression of the patient's tooth arch is obtained by, for example, conventional methods known to one of ordinary skill in the art. The dental impression may be prepared using a dental tray filled with polyvinlysiloxane, for example. Next, a positive mold of the tooth arch is cast from the negative impression by casting techniques including, but not limited to, those disclosed herein, those known to one of ordinary skill in the art, and improvements and combinations thereof.

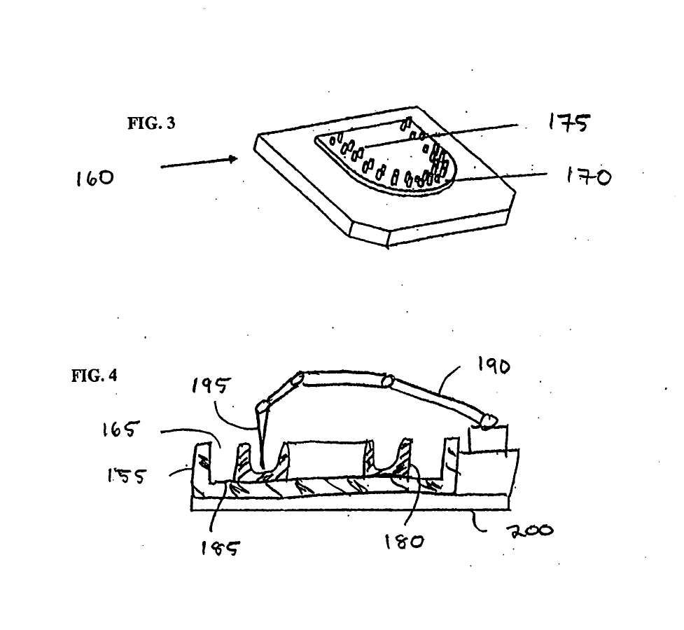

FIG. 2 shows an example casting chamber 150 that may be used in some variations to cast a positive mold of the tooth arch from the negative impression. Casting chamber 150 comprises a chamber body 155 and a lid 160. Chamber body 155 includes a cavity 165 in which the negative impression of the dental arch may be placed. Casting chamber body 155 and lid 160 may also include pins and alignment holes, not shown, allowing lid 160 to be precisely and reproducibly placed on chamber body 155. FIG. 3 shows the underside of lid 160 to which has been attached a base plate 170 onto which a positive model of the tooth arch may be cast. The fabrication of base plate 170 is described below. Lid 160 and base plate 170 also optionally include alignment pins and alignment holes, not shown, allowing base plate 170 to be precisely and reproducibly placed with respect to lid 160 and thus chamber body 155.

Referring now to FIG. 4, the negative impression 180 of the patient's tooth arch is placed in casting chamber body 155 and coupled (e.g., glued, bonded, interlocked, etc.) to the bottom 185 of casting chamber cavity 165. A three dimensional position input device (e.g., a 3-D digitizer) 190 is then utilized to determine the locations and orientations of the teeth in the negative impression of the tooth arch. In some variations position input device 190 is a mechanical location determination device such as, for example, a MicroScribe®, available from Immersion Corporation. In the example shown in FIG. 4, position input device 190 is such a mechanical location determination device including a stylus 195 that may be positioned at points within negative impression 180. Position input device 190 may then measure, for example, the spatial orientation of stylus 195 and/or the position of its tip.

In other variations, the locations and orientations of the teeth in the negative impression of the tooth arch may be determined, for example, by acquiring images of the negative impression and/or scanning the negative impression. Such use of images is disclosed, for example, in International Patent Application No. PCT/US2005/045351 titled “IMAGE BASED ORTHODONTIC TREATMENT METHODS,” filed Dec. 14, 2005. Various suitable scanning techniques are disclosed, for example, in International Patent Application No. PCT/US2005/039715 titled “METHODS AND APPARATUSES FOR MANUFACTURING DENTAL ALIGNERS,” filed Nov. 2, 2005.

Referring again to FIG. 4, to facilitate the measurement of the locations and orientation of the teeth in negative impression 180, position input device 190 and casting chamber body 155 may be fixed to a common platform 200. A coordinate system based on casting chamber body 155 can then be established by manipulating stylus 195 to measure the locations of two points on the casting chamber body 155 to define the x axis. The y axis may be established with a third reading. For example, the x-y plane may be defined on the surface that receives the negative impression. The z axis can be determined by taking the cross product of the x and y axes. The locations and orientations of the teeth in negative impression 180 may then be measured with respect to the coordinate system on chamber body 155 by placing stylus 195 at points on or in the tooth impressions. A computer may then be used to record the position of stylus 195. In one variation, the placement of stylus 195 is controlled by an operator. In another variation, an automated system having optical and/or tactile feedback is utilized to position stylus 195.

After the locations and orientations of the teeth in negative impression 180 have been acquired, base plate 170 (FIG. 3) is fabricated to include one or more sockets or other receptacles (e.g., drill holes) located and oriented to correspond to the location and orientation of each tooth in the tooth arch. Pins 175 are then inserted into the sockets. The socket locations and orientations may be chosen such that pins 175 approximately correspond to the positions of the roots of the teeth. The socket locations and orientations may also be chosen so that the sockets and pins of neighboring teeth do not interfere with each other. In variations in which the position of base plate 170 attached to lid 160 can be precisely determined when lid 160 is attached to chamber body 155, the coordinate system in which position input device 190 (FIG. 4) characterized negative impression 180 can be easily transposed to the base plate 170. This can facilitate accurate and precise fabrication of the sockets in base plate 170.

Base plate 170 may be made from materials including, but not limited to, plastics, metals, and machineable waxes. The sockets in base plate 170 may be formed by methods including, but not limited to, computer numerical control based machining (e.g., drilling), laser machining, and printing or forming sockets in a soft material which is later cured or hardened.

As shown in FIG. 5, after pins 175 are inserted into base plate 170, base plate 170 is attached to casting chamber lid 160, and lid 160 is flipped over and placed on top of chamber body 155 holding the negative impression 180 of the tooth arch. In the illustrated example, when the lid 160 and chamber body 155 are properly aligned, each pair of pins in base plate 170 corresponds to a tooth in the tooth arch represented by the negative impression.

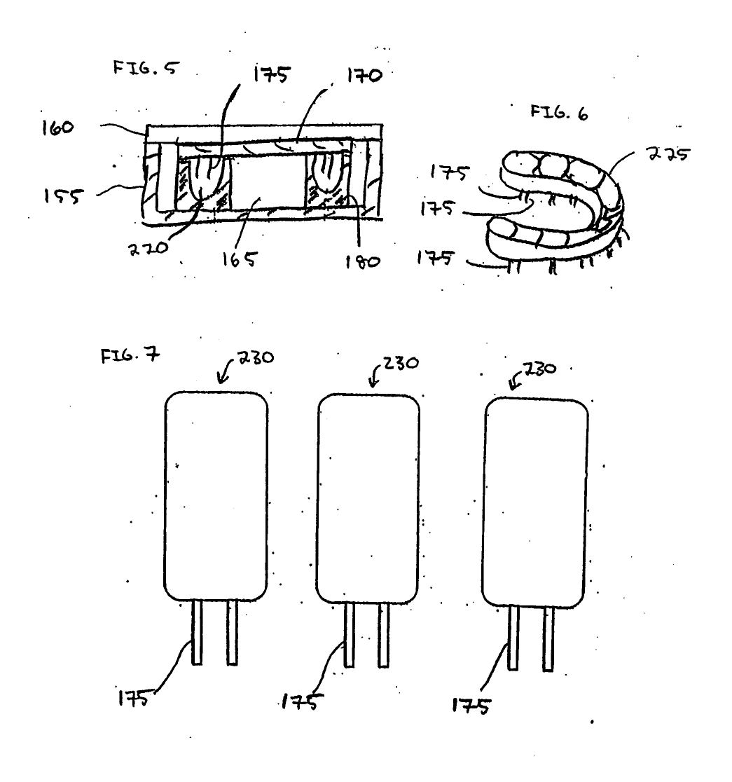

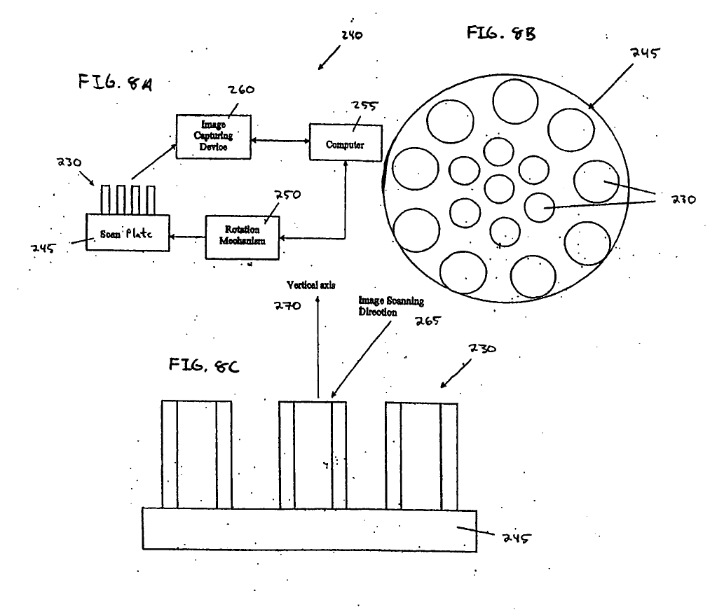

Next, a casting material is injected into the cavity 220 of the negative impression 180, which is positioned within the casting chamber cavity 165. Suitable casting materials include, but are not limited to, epoxy materials, polymers, and plasters. Optionally, heat, infrared light, or ultraviolet light, for example, may be applied to promote curing of the casting material. The casting material cures to form a positive arch 225 (FIG. 6) within the negative impression, with pins 175 bonded to the positive arch. In some variations positive arch 225 is cast by sequentially applying and curing multiple layers of casting material to form a layered model of the dental arch. Examples of multi-layer casting methods and devices are disclosed in U.S. patent application Ser. No. 11/258,465, entitled “MULTI-LAYER CASTING METHODS AND DEVICES,” filed Oct. 24, 2005.

After positive arch 225 has cured and/or hardened, it is decoupled from negative impression 180. The teeth in the positive tooth arch 225 are then separated to form physical models 230 of the individual teeth, as shown in FIG. 7. Separation may be achieved by, for example, sawing, laser cutting, or other techniques that are well known to one of ordinary skill in the art.

After the separation of positive tooth arch 225, individual physical tooth models 230 may be digitized as described next, for example, to form digital models of the individual teeth. Examples of digitization of physical tooth models and construction of a digital dental arch from digital models of teeth are disclosed, for example, in International Patent Application No. PCT/US2005/039715 titled “METHODS AND APPARATUSES FOR MANUFACTURING DENTAL ALIGNERS,” filed Nov. 2, 2005.

In one variation, physical tooth models 230 are digitized by scanning system 240 shown in FIG. 8A. Scanning system 240 includes a scan plate 245 on which one or more physical tooth models 230 can be mounted. Scan plate 245 can be rotated by a rotation mechanism 250 under the control of a computer 255. The rotation mechanism 250 can include a motor and a gear transport mechanism that is coupled to the scan plate 245. As scan table 245 rotates, an image capture device 260 captures images of physical tooth models 230. The coordinates of a plurality of surface points on the physical tooth models 230 can be computed, for example, by triangulation using the captured image data. The surfaces of the physical tooth models 230 can be constructed by interpolating computed coordinates of the points on the surface. Image capture device 260 can be, for example, a digital camera, digital video camera, laser scanner, or other optical scanner. Some variations utilize a plurality of image capture devices. The throughput and accuracy of the digitization process may increase with the number of image capture devices used.

In some variations, the individual physical tooth models 230 are placed on scan plate 245 one at a time and scanned one at a time. In other variations, a plurality of individual physical tooth models 230 are place onto scan plate 245 and scanned together. For example, in one variation eight physical tooth models 230 are scanned at a time. In another variation sixteen physical tooth models 230 are scanned at a time. In general, the scanning throughput is increased with increased packing density on scan plate 245. However, higher packing density may decrease the distance between the physical tooth models 230, which may cause the adjacent physical tooth models 230 to block each other in image captures. Various techniques that are well known to one of ordinary skill in the art may be utilized to determine the desired packing density and distribution pattern for placement of physical tooth models 230 on scan plate 245.

FIG. 8B is a top view, illustrating one variation of a tooth model platform for scanning. In this variation, two or more physical tooth models 230 are mounted to a scan plate 245. Physical tooth models 230 can have different sizes and shapes. In the example of FIG. 8B the small circles may be, for example, about 10 mm in diameter and represent small teeth (e.g., lower incisors, canine, etc.) or tooth components. The large circles may be, for example, about 15 mm in diameter and represent large teeth (e.g. upper central incisors, molars) or larger tooth components. In this example, physical tooth models 230 are placed, for example, at least about 5 mm apart from each other and at almost equal height to avoid overlap. Scan plate 245 may be about 150 mm in diameter, for example. The packing efficiency of physical tooth models 230 can be determined by their sizes, heights, and shapes and by their distribution on scan plate 245. As one of ordinary skill in the art having the benefit of this disclosure would appreciate, other distributions of physical tooth models 230 on a scan plate 245 differing from that shown in FIG. 8B may also be suitable.

FIG. 8C shows a side view of scan plate 245 in one variation. Physical tooth models 230 are mounted on scan plate 245 in a substantially vertical orientation. Images of the physical tooth models are scanned or captured from a direction 265 oblique to the physical tooth models 230 such that their top and side surfaces can be captured at different angles as scan plate 245 is rotated. For example, the image capture direction 265 can be about 45 degree off vertical axis 270. Other relative orientations of the image capture direction 265 and the physical tooth models may also be suitable. In some variations scan plate 245 can be mounted on goniometer and/or translation stages which can provide up to 6 axes for 6 degree of freedom movements.

In some variations, physical tooth models 230 are mounted on scan plate 245 by inserting pins 175 on physical tooth models 230 into sockets formed in scanning plate 245. The positions and orientations of the sockets are precisely known. Hence, the positions and orientations of pins 175 and physical tooth models 230 during the scanning process can be determined in relation to the sockets. Thus, once the surface of a physical tooth model 230 has been digitized, the coordinates of the surface of that tooth are known with respect to the positions of the pins in that tooth. That is, the location of points on the surface of a digitized tooth and the location of the pins in that tooth can be translated into the same coordinate system. Consequently, if the positions of the pins are known or defined, then the positions of points on the surface of the tooth are also known.

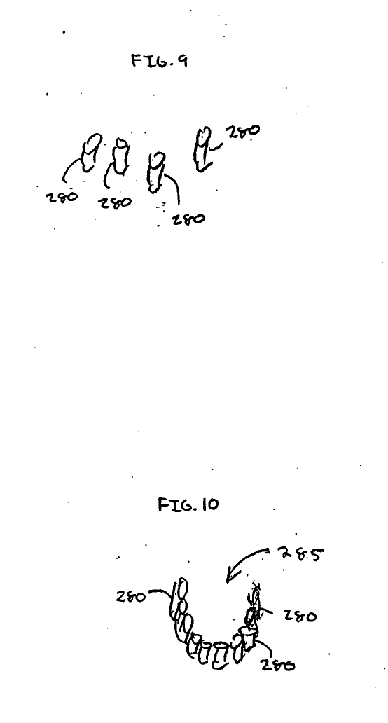

FIG. 9 illustrates examples of graphic projections of the individual digital representations 280 of selected teeth, each of which comprises a crown portion of the corresponding tooth. In one variation, a section of the gingival tissue (not shown) is also digitized.

Digital tooth models may also be generated from physical tooth models by, for example, other methods known to one of ordinary skill in the art and by image-based methods disclosed in International Patent Application No. PCT/US2005/045351 titled “IMAGE BASED ORTHODONTIC TREATMENT METHODS,” filed Dec. 14, 2005.

Once the individual physical tooth models 230 have been digitized, the digital representations 280 of individual teeth may be utilized by a computer program to generate a digital representation 285 (FIG. 10) of the patient's current tooth arch. In some variations, the computer uses the relative locations and orientations of pins 175 in positive arch 225 (or, equivalently, in base plate 170) to calculate the relative positions of corresponding digital tooth models 280 required to align digital tooth arch model 285 with positive arch 225.

In other variations, the relative locations and orientations of the teeth in the current tooth arch may be determined, for example, by acquiring images of or scanning the patient's tooth arch, negative impression 180, or positive arch 225 and then used to arrange digital tooth models 280. The relative positions of the teeth may be determined from the image or scan data by, for example, conventional methods known to one of ordinary skill in the art and/or by methods disclosed in the international patent applications cited above.

In yet other variations, a preliminary digital model of the current tooth arch is generated by acquiring images of or scanning the patient's tooth arch, negative impression 180, or positive arch 225 by, for example, conventional methods known to one of ordinary skill in the art and/or by methods disclosed in the international patent applications cited above. Digital tooth models 280 are then superimposed on the preliminary digital model of the current arch, and their locations and orientations are adjusted to match those of the corresponding teeth in the initial digital model. The resulting digital model of the current tooth arch generated from digital tooth models may include information not present in the preliminary digital model.

Although the approach just described utilized digital tooth models 280 in the generation of digital model 285 of the patient's current tooth arch, this need not be necessary. For example, in some variations a suitable digital model of the patient's current tooth arch may be generated by acquiring images of or scanning the patient's tooth arch, negative impression 180, or positive arch 225 without incorporating additional information from scans or images of individual teeth or groups of teeth.

In some variations, the teeth in the digital model of the current tooth arch include roots. The roots may be added to digital tooth models 280 prior to arranging the digital teeth to model the current tooth arch. Alternatively, the roots may be added to the teeth in the digital model of the current tooth arrangement after the crown portion of the model has been generated. Information from x-rays of the patient's tooth arch may be used in generating such digital tooth roots.

Although the generation of a digital model of only a single (e.g., upper or lower) tooth arch was described above, one of ordinary skill in the art having the benefit of this disclosure would appreciate that digital models of both upper and lower tooth arches may be prepared by the methods and apparatus disclosed above.

Referring again to FIG. 1, in step 105 of the exemplary process for manufacturing a dental aligner physical tooth models of the patient's teeth are arranged to form a physical model of a target arrangement of the patient's teeth. In some variations, physical tooth models to be arranged to form a physical model of a target arch are fabricated by casting a positive mold of the patient's tooth arch from a negative impression of the tooth arch and then separating the positive mold into individual physical tooth models or physical models of groups of teeth in a manner similar or identical to that described above. In other variations, a digital model of the patient's current tooth arch is obtained by any of the methods described above, for example, and then physical models of individual teeth or groups of teeth are manufactured from the digital model of the current tooth arch using, for example, computer numerical control manufacturing techniques. In yet other variations, a physical model of the patient's tooth arch is manufactured from a digital model of the current tooth arch using, for example, computer numerical control manufacturing, and then separated into individual physical tooth models or physical models of groups of teeth. Computer numerical controlled manufacturing techniques suitable for manufacturing a physical model of a tooth arch or physical models of individual teeth or groups of teeth include, but are not limited to, conventional stereolithography methods which selectively harden a liquid or resin into a three dimensional structure.

The physical tooth models may be arranged to form a physical model of the target arch on a conventional dental wax base plate by conventional dental model building methods, for example. Other base plate materials known to one of ordinary skill in the art and allowing the construction of a physical model of the target arch from physical tooth models may also be used, however. The physical tooth models may be arranged on the base plate according to an orthodontist's prescription, for example. In some variations, one or more of the physical tooth models that are arranged to form the physical model of the target arrangement each include one or more detachable handles that allow an operator to easily manipulate the physical tooth models.

In some variations, the physical tooth models are first arranged to form a physical model of the current arrangement of the patient's teeth, and then rearranged to form the physical model of the target arrangement. This procedure may make it easier to later determine the correspondence between the teeth in the digital model of the current arrangement and the teeth in the digital model of the target arrangement generated from the physical model of the target arrangement, because the differences in location and orientation for each tooth between the current and target arrangements may be determined from the physical models. For the same reason, this procedure may make it easier to establish a common coordinate system for the digital models of the current and target arches. Although advantageous in some variations, this procedure is not necessary, however.

Positional information allowing arrangement of physical tooth models to model the patient's current arrangement of teeth may be acquired, for example, as described above with respect to positional information used in the generation of a digital model of the current tooth arch from digital models of individual teeth. In addition, the relative positions of physical tooth models required to model the patient's current tooth arch may also be derived from a previously generated digital model of the current tooth arch (generated at step 100, for example).

Referring to FIGS. 11 and 12, in some variations sockets or other receptacles 290 are formed in a machineable wax base plate 295 to receive physical tooth models 230 to form a physical model 300 of the current arrangement of the patient's teeth. The relative locations and orientations of sockets 290 may be the same as those used in the fabrication of base plate 170 (FIG. 3), for example, in which case the physical tooth models 230 may then be coupled to sockets 290 with pins 175. The machineable wax base plate may be formed, for example, from bulk machineable wax available from Freeman Manufacturing & Supply Company. Sockets 290 in base plate 295 may be formed by methods including, but not limited to, computer numerical control based machining (e.g., drilling), laser machining, and printing or forming sockets in the wax when it is in a softened state, and then hardening the wax.

Base plate 295 may be placed on a heater 305 (FIG. 12) and heated to soften at least a part of base plate 295 to allow the location and/or orientation of one or more of physical tooth models 230 to be altered. In some variations heater 305 may heat all of base plate 295 in a substantially uniform manner. This may be accomplished, for example, with a heater 305 comprising a heat conductive plate heated by one or more heating elements. In other variations, heater 305 may selectively heat portions of base plate 295 underlying one or more selected physical tooth models 230. In such cases heater 305 may comprise, for example, individually controllable conventional heating elements arranged in a grid pattern or other similar array to allow such localized heating. In other variations, some or all of the physical tooth models include heating elements (e.g., tungsten wire heating elements) that may be used to soften wax base plate 295 beneath the physical tooth models, and heater 305 is not necessarily present. In yet other variations, one or more localized portions of wax base plate 295 is heated with ultraviolet, visible, or infrared light or microwave radiation, and heater 305 is not necessarily present.

After the location and/or orientation of one or more physical tooth models have been altered, base plate 295 may be cooled or allowed to cool to harden and thereby maintain physical tooth models 230 in the new arrangement. Physical tooth models 230 may be rearranged in a single step to form the physical model 310 of the target arrangement. Alternatively, the process of softening the wax, altering locations and/or orientations of physical tooth models 230, and hardening the wax may be repeated one or more times to form the physical model 310 of the target arrangement. In the latter case, the successive alterations in the locations and orientations of physical tooth models 230 may follow a proposed treatment plan or occur as part of the development of a treatment plan.

In other variations, the physical tooth models are attached to a base plate using adjustment jigs which allow the locations and orientations of the physical tooth models to be modified. Such jigs may facilitate construction of the physical model of the target arch. In addition, use of such jigs may also allow the physical tooth models to be initially arranged to form a physical model of the current arrangement of the patient's teeth, and then rearranged to form the physical model of the target arch as described above. The use of such jigs is disclosed, for example, in International Patent Application No. PCT/US2005/039715 titled “METHODS AND APPARATUSES FOR MANUFACTURING DENTAL ALIGNERS,” filed Nov. 2, 2005.

Adjustment jigs may take various forms. An example adjustment jig 315 is shown in FIG. 14. Adjustment jig 315 includes a universal joint 320 mounted on a translation stage 325. In the illustrated example, universal joint 320 includes a pin 330 to which a physical tooth model may be attached. In other examples, universal joint 320 may include sockets or other receptacles to which pins or other attachment features on a physical tooth model may be attached. Other means of attaching a physical tooth model to jig 315 may be used as well. Clamping mechanism 335 may be used to lock universal joint 320 into a desired orientation. Translation stage 325 may be attached to a base plate comprising, for example, one or more sockets or other receptacles configured to receive the adjustment jig. The combination of the universal joint 320 and the translation stage 325 may enable an attached physical tooth model to be adjusted with six degrees of freedom relative to the base and relative to other physical tooth models in a physical model of a tooth arch.

The positions of the physical tooth models may be tracked in real time as they are rearranged to form the physical model of the target arrangement. This may be accomplished, for example, by acquiring real-time images of the physical tooth models as they are moved or with conventional motion tracking sensors and methods known to one of ordinary skill in the art.

Rearrangement of physical tooth models to form a physical model of the target arch as described above may occur according to an orthodontist's prescription or under the guidance of an orthodontist or other dental professional, for example.

Referring once again to FIG. 1, in step 110 of the exemplary process for manufacturing a dental aligner a digital model of the target arrangement of the patient's teeth is generated from the physical model of the target arrangement constructed in step 105. This may be accomplished, for example, using methods similar or identical to any of those described in step 100 for generating a digital model of the current arrangement of the patient's teeth.

The digital model of the target tooth arch may be generated, for example, from digital models of the patient's individual teeth or of groups of the patient's teeth which were generated, for example, as described above with respect to step 100. In some variations, the relative positions of the digital tooth models required for the digital model of the target arch may be determined from the relative positions of the physical tooth models in the physical model of the target arch. The positions of the physical tooth models may be determined, for example, by acquiring images of or scanning the physical model of the target arch, or by physically measuring (e.g., by hand) the positions of the physical tooth models.

In other variations, a preliminary digital model of the target arch is generated, for example, by acquiring images of or scanning the physical model of the target arch. The relative positions of digital tooth models required to form a digital model of the target arch may then be determined by matching the digital tooth models to the teeth in the preliminary digital model of the target arch. The resulting digital model of the target arch generated from digital tooth models may include information not present in the preliminary digital model.

It is not necessary to generate the digital model of the target arch from digital models of individual teeth or groups of teeth, however. For example, the digital model of the target arch may be generated from information acquired solely by imaging or scanning the physical model of the target arch.

As noted above, a common coordinate system for the digital models of the current and target arches may be established, for example, by rearranging a physical model of the current arch to form the physical model of the target arch and determining the resulting differences in locations and orientations of the physical tooth models. A common coordinate system may also be established, for example, by identifying the corresponding teeth in the digital models of the current and target tooth arches. Corresponding teeth in the digital models may be determined, for example, by superimposing individual teeth or groups of teeth from one model onto the other.

It should also be noted that, like digital models of the patient's current tooth arches, digital models of target arches may also include digital models of the roots of the teeth.

Next, in step 115 of the exemplary process for manufacturing a dental aligner, one or more digital models of arrangements of the patient's teeth intermediate between the current and target arrangements are generated from the digital models of the current and target arrangements. This may be accomplished, for example, using conventional computer modeling techniques known to one ordinary skill in the art including, but not limited to, linear and non-linear interpolation.

Software supporting a user interface may allow an operator to modify and/or specify positions of teeth in the digital tooth arch models. In some variations, an operator may specify particular intermediate positions for particular teeth but allow other intermediate positions for the teeth to be determined automatically by interpolation, for example. Also, in some variations an operator may modify or specify tooth positions to generate all or some of the intermediate digital models based on the operator's judgment, for example, without recourse to interpolation or other automatic model generating techniques. In other variations, the intermediate digital models may be generated automatically.

Software generating or enabling an operator to generate intermediate digital tooth arch models may also impose anatomically-derived limitations on the extent of movement and/or force applied to each tooth. In some variations, the software detects and prevents and/or alerts an operator to interference between teeth (e.g., collisions of crowns or roots) resulting from an attempt to modify the positions of one or more teeth to generate an intermediate arrangement.

Next, in step 120 of the exemplary process for manufacturing a dental aligner, one or more dental aligners are fabricated based on the one or more digital models of intermediate arrangements generated in step 115. This may be accomplished, for example, by methods disclosed in International Patent Application No. PCT/US2005/039715 titled “METHODS AND APPARATUSES FOR MANUFACTURING DENTAL ALIGNERS,” filed Nov. 2, 2005.

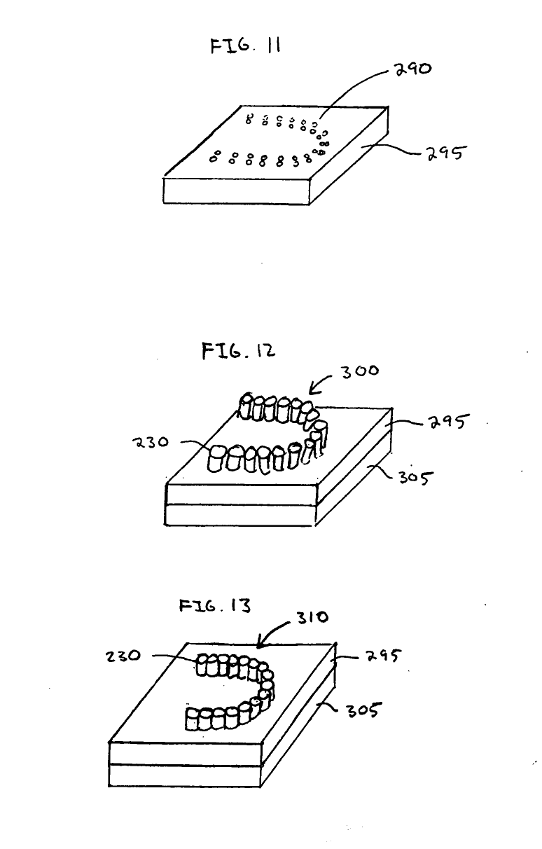

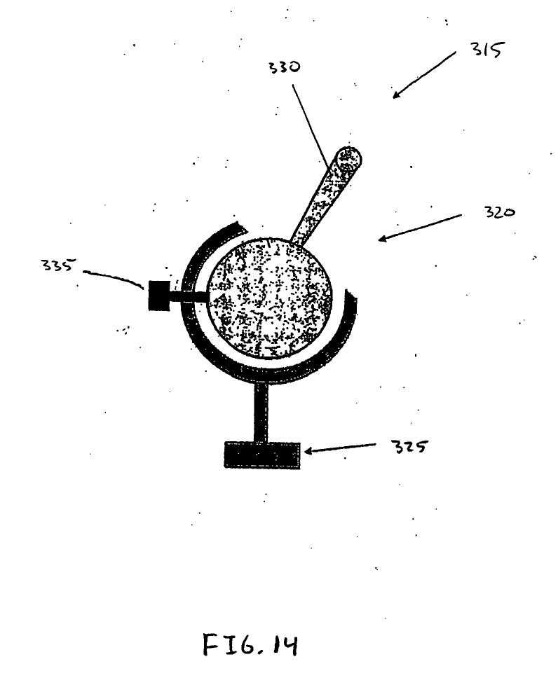

In some variations, a digital model of an intermediate tooth arch may be used to fabricate a physical model of the intermediate tooth arch which is then used to fabricate a dental aligner by, for example, forming a sheet of aligner material over the model. The digital model may be used as a reference to arrange physical tooth models on a base plate to form the physical model of the intermediate tooth arch. For example, the digital model of the intermediate tooth arch may include the positions of pins on physical tooth models corresponding to the teeth in the digital model. The locations and orientations of these pins may be used, for example, to form sockets or other receptacles (e.g., drill holes) in a base plate to receive the physical tooth models in the intermediate arrangement. The resulting physical model of the intermediate arrangement may be similar to the physical models of current and target tooth arches shown in FIGS. 12 and 13, for example.

The sockets for the physical tooth models may be formed by methods including, but not limited to, computer numerical control based machining (e.g., drilling), laser machining, and printing or forming sockets in a soft material which is later cured or hardened. The base plate for the model may be made from materials including, but not limited to, plastics, metals, and machineable waxes. The physical tooth models may be formed, for example, by methods described above with respect to previous steps in the exemplary process for manufacturing a dental aligner. Pin locations in physical tooth models and corresponding socket locations in the base plate may be chosen to avoid interference between the pins of neighboring physical tooth models. As physical tooth models are placed onto a base plate, an operator may adjust the physical tooth models (e.g., shaving, or rounding out sections of the tooth profile, etc.) to ensure that a proper fit between the physical tooth models can be achieved.

The digital model of the intermediate tooth arrangement may also be used to fabricate a physical model of the intermediate arrangement by, for example, computer numerical control manufacturing techniques such as conventional stereolithography methods which selectively harden a liquid or non-hardened resin into a three dimensional structure.

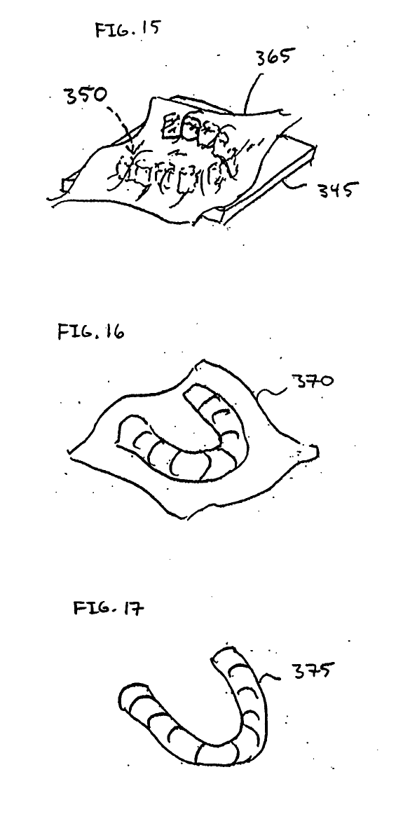

In some variations, the desired aligner is fabricated using a physical model of the intermediate tooth arch in a vacuum forming process. For example, as shown in FIG. 15, a sheet of aligner material 365 may be placed over an intermediate physical tooth arch model 350 arranged or formed on base plate 345. Sheet 365 may be heated and then vacuum formed around physical tooth arch model 350 by, for example, a vacuum pump that removes air at the bottom of base plate 345 to cause the softened aligner material 365 to fittingly form around physical dental arch model 350. Suitable aligner materials include but are not limited to polymers known to one of ordinary skill in the art. In some variations, gaps or voids between teeth in the tooth arch model are filled before the aligner is vacuum formed so that the aligner may be more easily removed from the dental arch at the conclusion of the vacuum forming process.

As shown in FIG. 16, vacuum-formed sheet 370 of aligner material may be removed from physical tooth arch model 350 after it has sufficiently cooled. Excess materials on the vacuum-formed polymeric sheet 370 may then be trimmed off to form a polymeric shell 375 that can serve as a removable aligner, as shown in FIG. 17.

In other variations, a digital model of a dental aligner is generated from a digital model of an intermediate arrangement of the patient's teeth. A physical dental aligner may then be manufactured from the digital model of the dental aligner using, for example, computer numerical control based manufacturing techniques. Suitable CNC manufacturing methods and apparatus include, but are not limited to, those disclosed at various points above.

Several variations have been provided for each of steps 100-120 in the exemplary process for manufacturing a dental aligner. The exemplary process may be executed using any suitable combination of variations of these steps. Several illustrative examples of such combinations are described next. These examples are not meant to be limiting.

In one example, a negative impression of a patient's current tooth arch is obtained. The relative locations and orientations of the teeth are determined from the negative impression. A positive cast is made from the negative impression and separated into physical tooth models each of which includes one or more pins that may be used to attach the physical tooth model to a base. The physical tooth models are digitized, and a digital model of the current arrangement of the patient's teeth is generated from the digital tooth models. Physical tooth models are arranged on a base to form a physical model of the current arch, and then rearranged to form a physical model of a target tooth arrangement. A digital model of the target tooth arrangement is generated from the digital tooth models generated earlier and from the relative positions of the corresponding physical tooth models in the physical model of the target arch. Digital models of intermediate tooth arrangements are generated from the digital models of the current and target tooth arrangements. A digital model of an intermediate arrangement is used to arrange physical tooth models on a base to form a physical model of the intermediate arrangement. A dental aligner is then manufactured by vacuum forming a suitable material over the physical model of the intermediate arrangement.

In another example, a negative impression of the patient's current tooth arch is obtained. A positive mold is cast from the negative impression. The positive mold is scanned, and a digital model of the patient's current tooth arch is generated from the scan data. Physical tooth models are generated from the digital model of the current tooth arch, a physical model of the tooth arch is generated from the digital model and then separated into physical tooth models, or a positive mold cast from the negative impression is separated into physical tooth models. Physical and digital models of the target arch and digital models of intermediate tooth arrangements are generated similarly to as described in the previous example. A physical model of an intermediate tooth arch is manufactured based on a digital model of the intermediate tooth arch using a computer numerical control manufacturing techniques such as, for example, conventional stereolithography. A dental aligner is then formed by vacuum forming a suitable material over the physical model of the intermediate arrangement.

As noted earlier, variations of the process shown in FIG. 1 need not include all depicted steps, need not execute the steps in the order depicted, and may include additional steps. For example, a method is disclosed above for generating one or more arrangements of a patient's teeth. The method comprises acquiring a physical model of an arrangement of the patient's teeth that is modified compared to the current arrangement of the patient's teeth, and then generating a digital model of the modified arrangement from the physical model of the modified arrangement. The modified arrangement may differ from the current arrangement by, for example, rotation and/or translation of one or more teeth, removal of one or more teeth, and/or addition of a crown or denture. The physical model of the modified arrangement may be acquired, for example, using any suitable combination or subcombination of apparatus and techniques described with respect to steps 100 and 105 in FIG. 1. The digital model may be generated, for example, using any suitable combination or subcombination of apparatus and techniques described with respect to step 110. The resulting digital model may be used for any suitable purpose, including those described above.

Some methods disclosed above for generating one or more digital models of one or more arrangements of a patients teeth comprise attaching a plurality of physical tooth models of the patient's teeth to a platform configured to receive them in an arrangement modeling a current arrangement of the patient's teeth, altering the arrangement of the physical tooth models to model a modified arrangement of the patient's teeth, and generating a digital model of the modified arrangement of the patient's teeth from the altered arrangement of physical tooth models. This may be accomplished, for example, using any suitable combination or subcombination of apparatus and techniques described with respect to steps 100-110. The resulting digital model may be used for any suitable purpose, including those described above.

This invention has been described and specific examples of the invention have been portrayed. While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well. Finally, all publications and patent applications cited in this specification are herein incorporated by reference in their entirety as if each individual publication or patent application were specifically and individually put forth herein.

What is claimed is:

1. A method for fabricating one or more dental aligners for repositioning a patient's teeth from a current arrangement to a target arrangement through at least one arrangement intermediate between the current arrangement and the target arrangement, the method comprising:
acquiring a digital model of the current arrangement of the patient's teeth;
arranging a plurality of physical tooth models of the patient's teeth to form a physical model of the target arrangement;
generating a digital model of the target arrangement from the physical model of the target arrangement;
generating one or more digital models of intermediate arrangements from the digital model of the current arrangement and the digital model of the target arrangement; and
fabricating one or more dental aligners from the one or more digital models of intermediate arrangements.

2. The method of claim 1, wherein acquiring the digital model of the current arrangement comprises digitizing at least one of: the patient's tooth arch, a negative impression of the patient's tooth arch, and a positive model of the patient's tooth.

3. The method of claim 1, wherein acquiring the digital model of the current arrangement comprises acquiring images of at least one of: the patient's tooth arch, a negative impression of the tooth arch, and a positive model of the tooth arch.

4. The method of claim 1, wherein acquiring the digital model of the current arrangement comprises:
acquiring a negative impression of the patient's tooth arch;
casting a positive model of the tooth arch from the negative impression;
separating the positive model into the plurality of physical tooth models;
generating a plurality of digital tooth models from the plurality of physical tooth models; and
generating the digital model of the current arrangement from the digital tooth models.

5. The method of claim 1, further comprising:
acquiring a negative impression of the patient's tooth arch;
casting a positive model of the tooth arch from the negative impression; and
separating the positive model into the plurality of physical tooth models.

6. The method of claim 1, further comprising fabricating the plurality of physical tooth models by computer numerical control manufacturing based on the digital model of the current arrangement.

7. The method of claim 1, further comprising:
fabricating a physical model of the patient's current tooth arch based on the digital model of the current arrangement; and
separating the physical model of the tooth arch into the plurality of physical tooth models.

8. The method of claim 1, wherein arranging the plurality of physical tooth models comprises:
arranging the plurality of physical tooth models to form a physical model of the current arrangement; and
rearranging the plurality of physical tooth models to form the physical model of the target arrangement.

9. The method of claim 8, wherein the physical tooth models are arranged on a wax base.

10. The method of claim 9, wherein the wax base includes at least one receptacle for each of the physical tooth models such that when the physical tooth models are coupled to the receptacles the physical tooth models form the physical model of the current arrangement.

11. The method of claim 10, further comprising:
heating the wax base to soften at least a part of it;
altering the location, orientation, or both location and orientation of at least one physical tooth model; and
hardening the wax.

12. The method of claim 8, wherein the physical tooth models are attached to a base plate using jigs that allow the locations, orientations, or locations and orientations of the physical tooth models to be adjusted.

13. The method of claim 1, wherein generating the digital model of the target arrangement comprises:
acquiring a plurality of digital tooth models of the patient's teeth; and
acquiring the relative locations and orientations of the physical tooth models in the physical model of the target arrangement.

14. The method of claim 1, wherein generating the digital model of the target arrangement comprises acquiring one or more images of the physical model of the target arrangement.

15. The method of claim 1, wherein generating the digital model of the target arrangement comprises scanning the physical model of the target arrangement.

16. The method of claim 1, wherein generating the digital model of the target arrangement comprises:
generating a preliminary digital model of the target arrangement from the physical model of the target arrangement;
acquiring a plurality of digital tooth models of the patient's teeth; and
matching the plurality of digital tooth models to the preliminary digital model of the target arrangement.

17. The method of claim 1, wherein generating one or more digital models of intermediate arrangements comprises interpolating between the digital model of the current arrangement and the digital model of the target arrangement.

18. The method of claim 1, wherein fabricating one or more dental aligners comprises:
arranging the plurality of physical tooth models to form a physical model of one of the intermediate arrangements; and
forming a dental aligner over the physical model of the intermediate arrangement.

19. The method of claim 1, wherein fabricating one or more dental aligners comprises:
manufacturing a physical model of one of the intermediate arrangements by computer numerical controlled manufacturing based on a digital model of the intermediate arrangement; and
forming a dental aligner over the physical model of the intermediate arrangement.

20. The method of claim 1, wherein fabricating one or more dental aligners comprises:
generating a digital model of a dental aligner from one of the digital models of intermediate arrangements; and
manufacturing the dental aligner by computer numerical control manufacturing based on the digital model of the dental aligner.

21. A method for generating one or more digital models of one or more arrangements of a patient's teeth, the method comprising:
acquiring a physical model of a modified arrangement of the patient's teeth, wherein the modified arrangement is modified compared to a current arrangement of the patient's teeth; and
generating a digital model of the modified arrangement from the physical model of the modified arrangement and a plurality of digital tooth models of the patient's teeth.

22. The method of claim 21, wherein the physical model of the modified arrangement comprises a plurality of physical tooth models of the patient's teeth.

23. The method of claim 21, wherein the plurality of digital tooth models are generated from a plurality of physical tooth models.

24. The method of claim 21, further comprising:
acquiring a digital model of the current arrangement; and
generating one or more digital models of intermediate arrangements of the patients teeth from the digital model of the current arrangement and the digital model of the modified arrangement;
wherein the one or more intermediate arrangements are intermediate between the current arrangement and the modified arrangement in a dental treatment.

25. The method of claim 24, further comprising fabricating one or more dental appliances from the one or more digital models of intermediate arrangements.

26. The method of claim 25, wherein at least one of the dental appliances is a dental aligner for repositioning the patient's teeth.

27. A method for generating one or more digital models of one or more arrangements of a patient's teeth, the method comprising:
attaching a plurality of physical tooth models of the patient's teeth to a platform configured to receive them in an arrangement modeling a current arrangement of the patient's teeth;
altering the arrangement of the physical tooth models to model a modified arrangement of the patient's teeth; and
generating a digital model of the modified arrangement of the patient's teeth from the altered arrangement of physical tooth models.

28. The method of claim 27, wherein the platform comprises a wax plate that includes a receptacle for each of the physical tooth models such that when the physical tooth models are coupled to the receptacles, the physical tooth models model the current arrangement of the patient's teeth.

29. The method of claim 28, further comprising:
heating the wax to soften it;
altering a location, orientation, or both location and orientation of at least one physical tooth model; and
hardening the wax.

30. The method of claim 27, wherein the platform comprises jigs to which the physical tooth models are attached, further comprising using at least one of the jigs to modify a location, orientation, or location and orientation of at least one of the physical tooth models.

31. The method of claim 27, further comprising:
acquiring a digital model of the current arrangement of the patient's teeth;
generating one or more digital models of one or more intermediate arrangements of the patient's teeth from the digital model of the current arrangement and the digital model of the modified arrangement, wherein the one or more intermediate arrangements are intermediate in a dental treatment between the current arrangement and the modified arrangement; and
fabricating one or more dental appliances from the one or more digital models of intermediate arrangements.

32. The method of claim 31, wherein at least one of the dental appliances is a dental aligner for repositioning the patient's teeth.
